(19) United States
(12) Patent Application Publication
(10) Pub. No.: US 2014/0106079 A1
(43) Pub. Date: Apr. 17, 2014

(54) System and Method for Producing a Structure with an Electrostatic Spray

(71) Applicant: Finishing Brands Holdings Inc., Minneapolis, MN (US)

(72) Inventors: Steven Andrew Myers, Scottsdale, AZ (US); Payton Xavier Cozart, Toledo, OH (US)

(73) Assignee: Finishing Brands Holdings Inc., Minneapolis, MN (US)

(21) Appl. No.: 14/046,838

(22) Filed: Oct. 4, 2013

Related U.S. Application Data
(60) Provisional application No. 61/712,764, filed on Oct. 11, 2012.

(51) Int. Cl. B05B 5/08; B24B 1/00

(52) U.S. Cl. CPC B05B 5/082; B24B 1/00
USPC 427/458; 118/621; 118/626; 700/283; 451/54

(57) ABSTRACT

A system, including an electrostatic spray system, including an electrostatic tool configured to spray a material with an electrostatic charge, and a target with a surface finish greater than or equal to a number 4 mirror finish configured to receive a material sprayed by the electrostatic tool.

### CROSS REFERENCE TO RELATED APPLICATION

This application claims priority to and benefit of U.S. Provisional Patent Application No. 61/712,764 entitled “SYSTEM AND METHOD FOR PRODUCING A STRUCTURE WITH AN ELECTROSTATIC SPRAY”, filed Oct. 11, 2012, which is herein incorporated by reference in its entirety.

### BACKGROUND

The invention relates generally to system and method for using an electrostatic tool.

Electrostatic tools spray electrically charged materials to more efficiently coat objects. For example, electrostatic tools may be used to paint objects. In operation, a grounded target attracts electrically charged materials sprayed from an electrostatic tool. As the electrically charged material contacts the grounded target, the material loses the electrical charge. Different materials lose electrical charges at different rates. Accordingly, some materials may not lose their electrical charge before more electrically charged material contacts the target. These residual charges may interfere with the overall coating and product finishes.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In one embodiment, a system, including an electrostatic spray system, including an electrostatic tool configured to spray a material with an electrostatic charge, and a target with a surface finish greater than or equal to a number 4 mirror finish configured to receive a material sprayed by the electrostatic tool.

In another embodiment, a system including an electrostatic spray system controller configured to change operating parameters of a electrostatic spray system that discharges electrically charged material with slow rates of electrical charge decay.

In another embodiment, a method for producing a part with an electrostatic spray system, including preparing a coating material, preparing a target for receipt of the coating material, adjust parameters of the electrostatic spray system, electrostatically spraying a coating material onto the target to create a layer of a wall, partially curing the layer of coating material, determining if a thickness of the wall is equal to or greater than a threshold, applying another layer of the coating material if the thickness is less than the threshold, curing the coating material, and removing the wall from the target.

### DRAWINGS

These and other features, aspects, and advantages of the present invention will become better understood when the following detailed description is read with reference to the accompanying drawings in which like characters represent like parts throughout the drawings, wherein:

FIG. 1 is a schematic of an electrostatic spray system;

FIG. 2 is a flowchart of an exemplary method for using the electrostatic spray system of FIG. 1;

FIG. 3 is a flowchart of an exemplary method for using the electrostatic spray system of FIG. 1;

FIG. 4 is a flowchart of an exemplary method for using the electrostatic spray system of FIG. 1;

FIG. 5 is a flowchart of an exemplary method for using the electrostatic spray system of FIG. 1;

FIG. 6 is a flowchart of an exemplary method for using the electrostatic spray system of FIG. 1;

FIG. 7 is a flowchart of an exemplary method for electrostatically producing a part;

FIG. 8 is a flowchart of an exemplary method for forming a mandrel;

FIG. 9 is a flowchart of an exemplary method for forming a mandrel with a coating;

FIG. 10 is a flowchart of an exemplary method for forming a mandrel with a coating;

FIG. 11 is a flowchart of an exemplary method for adjusting the parameters in a method for electrostatically producing a part;

FIG. 12 is a cross-sectional view of a mandrel with an unpolished coating;

FIG. 13 is a cross-sectional view of a mandrel with a polished coating;

FIG. 14 is a cross-sectional view of a mandrel with a polished coating and an electrostatically sprayed part; and

FIG. 15 is a cross-sectional view of mandrel with a polished coating separated from an electrostatically sprayed part.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

The present disclosure is generally directed towards an electrostatic system and methods for using the same. Specifically, the electrostatic system may fabricate products and coat objects using material with slow electrical charge decay (i.e., materials that once electrically charged do not easily lose charge). The slow electrical charge decay may interfere with proper product finishes and tolerances as the material starts to repel itself. The methods/processes described below advantageously enable an electrostatic system to fabricate products and coat objects with the proper tolerances and characteristics, using materials that have slow charge decay. For example, some of the embodiments described below may change the amount of electrical charge added to the sprayed material over time (i.e., periodically increase and decrease the electrical charge). This may advantageously allow the material to lose electrical charge by adding little or no charge for periods of time. In other embodiments, the electrostatic system may change the amount of sprayed material, thus giving the material more time to lose electrical charge by adding less overall charge to the coating or product. In still other embodiments, the disclosure provides methods for preparing a mandrel or target that enables production of products with the proper characteristics. For example, preparation of the mandrel may improve clarity/transparency of a product. The disclosed embodiments also describe methods that adjust various parameters that enable production of products within specific tolerances. These parameters may include bell speed, shaping air, distance between sprayer and mandrel (i.e., target), rotation percentage of the mandrel or electrostatic sprayer, angle of the electrostatic sprayer, partial cure time of the coating material (i.e., flash time), the amount of time the coating material is sprayed, the number of coatings, and the voltage applied to the material.

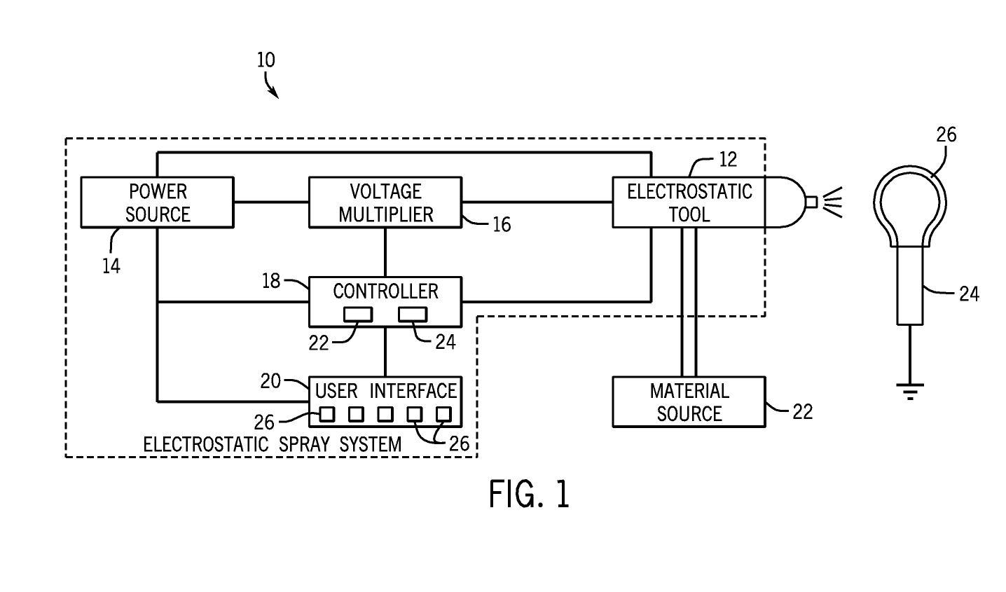

FIG. 1 is a schematic of an electrostatic spray system 10 that may use different processes to coat or produce products (implantable medical devices, syringe needles, stents, guide wires, catheters, etc.), with polymer materials that have slow rates of charge decay (silicon, polyethylene terephtalate (PET), low density polyethylene (LDPE), polyethylene films, etc.). Unfortunately, liquid silicon, among other polymer materials, may have a slow rate of electrical charge decay that can create poor finishes, because the material retains charge that may then repel additional material. Advantageously, the electrostatic spray system 10 may change the electric charge on the sprayed material over a period of time (e.g., periodically add less charge, remove all charge). The change in electric charge allows the material a period of time to lose electric charge (i.e., charge decay). The system 10 may also change how much charged material is sprayed. That is by spraying less material over a period of time less charge is added overall allowing the material to lose charge. The ability to change electric charge and change the amount of sprayed material enables system 10 to produce medical products with the proper finishes and tolerances. Accordingly, in accordance with the discussed embodiments, the electrostatic spray system may advantageously use different processes to produce products (e.g., medical products) with the proper finishes and tolerances using materials that have slow rates of electrical charge decay. The electrostatic spray system 10 includes an electrostatic tool 12, a power source 14, voltage multiplier 16, controller 18, and user interface 20. In operation, the electrostatic spray system 10 is configured to electrically charge and spray a material from material source 22. This material is sprayed onto a grounded target 24 (e.g., a mandrel) that electrically attracts the charged material due to the charge. As the material collects on the target 24, it may form a product/part 26 or a coating.

In operation, the electrostatic spray system 10 uses the power source 14 to power an electrostatic tool 12. The electrostatic tool 12 may be a rotary atomizer or air atomizer capable of providing particle size less 10, 15, 20, 25, 50, 75, 100, 150, 200, or 250 microns (e.g., approximately between 1-20 microns, 3-18 microns, 5-15 microns). In operation, the electrostatic tool 12 electrically charges, atomizes, and sprays the material from the material source 22. The material may be a material used in medical products (e.g., a polymer, liquid silicon) or another kind of material with a slow electrical charge decay.

In the illustrated example, the electrostatic spray system 10 uses the voltage multiplier 16 to electrically charge the material inside the electrostatic tool 12. The voltage multiplier 16 receives power from the power source 14. The power source 14 may include an external power source or an internal power source, such as an electrical generator. The voltage multiplier 16 receives power from the power source 14 and converts the power to a higher voltage to be applied to the material in the electrostatic tool 12. More specifically, the voltage multiplier 16 may apply power to the material with a voltage between approximately 5 kV and 100 kV or greater. For example, the power may be at least approximately 15, 25, 35, 45, 55, 65, 75, 85, 95, 100, kV. As will be appreciated, the voltage multiplier 16 may be removable and may include diodes and capacitors. In certain embodiments, the voltage multiplier 16 may also include a switching circuit that changes the power between a positive and a negative voltage.

As shown in FIG. 1, the electrostatic spray system 10 includes the controller 18 and user interface 20, each of which may be powered by the power source 14. As illustrated, the controller 18 includes a processor 22 and a memory 24. The memory 24 may store instructions (i.e., software code) executable by the processor 22 to control operation of the electrostatic spray system 10. The controller 18 may be coupled to the voltage multiplier 16 and the electrostatic tool 12 to monitor various operating parameters and conditions. For example, the controller 18 may execute instructions to monitor and control the voltage from the voltage multiplier 16. Similarly, the controller 18 may execute instructions to monitor and control the power from the power source 14. Furthermore, the controller 18 may execute instructions to monitor and control the actual voltage applied to the material in the electrostatic tool 12.

The user interface 20 connects to and receives information from the controller 18. In certain embodiments, the user interface 20 may be configured to allow a user to adjust various settings and operating parameters based on information collected by the controller 18. Specifically, the user may adjust settings or parameters with a series of buttons or knobs 26 coupled to the user interface 20. In certain embodiments, the user interface 34 may include a touch screen that enables both user input and display of information relating to the electrostatic spray system 10. For example, the user interface 20 may enable a user to adjust the voltage supplied by the voltage multiplier 16, turn the voltage on/off, and adjust the amount of material sprayed by the tool 12 using a knob, dial, button, or menu on the user interface 34. Moreover, the user interface 34 may include preprogrammed operating modes for an electrostatic spray system 10. These modes may be processes that change the electric charge added to a sprayed material over a period of time or that change the amount of material sprayed by the electrostatic system 10. The modes may include periodically adding and completely removing electric charge from a sprayed material; progressively increasing and decreasing electric charge on sprayed material; removing all charge from material at an end portion of a spraying cycle; gradually reducing the electric charge on the sprayed material to nothing; or changing the amount of electrically charged material that is sprayed. An operator may activate one or more modes using a button, knob, dial, or menu 26 on the user interface 34. These preprogrammed modes may be a specific process for manufacturing a product, a specific step in a process, or may correspond to operating parameters for the electrostatic spray system 10 (e.g., voltage level, material discharge rate, time).

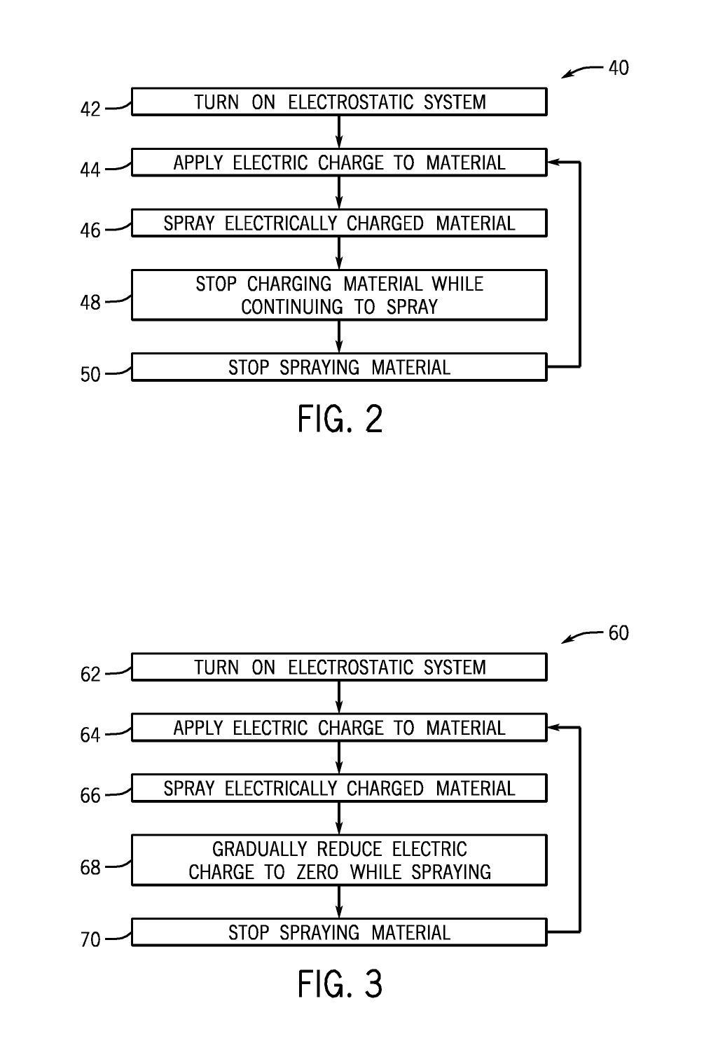

FIG. 2 is a flowchart of an exemplary method or process 40 for using or operating the electrostatic spray system of FIG. 1. This process 40 may advantageously remove electric charge from a sprayed material at an end portion of the spraying process to allow electric charge to dissipate. Thus enabling fabrication of a product (e.g., medical product) with the proper finishes and tolerances using a material with a slow electrical charge decay rate. The process 40 begins by turning on the electrostatic system 10. Once the electrostatic system 10 turns on, a user may interact with the user interface 20 to select a particular operating mode or operating parameters for the system 10. For example, a user may select a mode that runs process 40 for making a medical product or applying a coating. The user may also select specific operating parameters for process 40 (e.g., voltage level, amount of material to be sprayed, time period for applying voltage, etc.). The controller 18 receives this information from the user interface 20 and uses the information to operate the system 10. Specifically, the controller 18 uses the processor 22 to execute instructions contained in the memory 24.

After receiving instructions from the controller 18, the electrostatic tool 12 applies an electric charge to material from the material source 22, represented by step 44. The electric charge will be specific to the mode (i.e., positive or negative charge and approximately between 5-100 kV). In the next step, the electrostatic tool 12 begins spraying the electrically charged material at a target (e.g., a mandrel), represented by step 46. As explained above, some materials once electrically charged do not lose charge quickly; that is, they have a slow rate of electrical charge decay. Accordingly, the material already on the object 24 may repel freshly sprayed electrically charged material, creating poor finishes or improper tolerances.

Advantageously, the process 40 allows the excessive electrical charge to dissipate. Specifically, electrostatic tool 12 may stop charging material while continuing to spray, represented by step 48. The process step 48 therefore sprays electrical neutral material, on top of electrically charged material on the mandrel 24. By spraying electrical neutral material the electrically charged material on the mandrel 24 has an opportunity to lose some or all of its electrical charge. The electrical charge may decay by traveling to ground through the mandrel, dissipating into the freshly sprayed electrically neutral material, and/or traveling through the air to the grounded electrostatic tool 12. The decay in electric charge reduces the ability of the material already on the target to repel the freshly sprayed material, therefore producing a product or coating with the proper finish and tolerance. Moreover, the time period for executing the step in step 48 may change depending on how fast the material loses electrical charge. For example, step 48 may last approximately 1 second to 100 or more seconds (e.g., 1-5, 3-10, 5-15, 10-100 seconds). The time period may be user adjustable, or auto adjustable based on feedback from electrical charge flowing through the target (e.g., mandrel). The process 40 may then stop spraying material, represented by step 50. Depending on the product or coating, the process 40 may repeat itself after a specific time period (e.g., flash period or partial cure period). For example, the process 40 may repeat multiple times (e.g., 1, 2, 3, 4, 5, 10, 15, 20 or more times) before producing a finished product or coating. Again, each iteration of the process 40 may first apply the electrically charged material (block 46) followed by applying the material without a charge to improve the top finish of the coating(s).

FIG. 3 is a flowchart of an exemplary method or process 60 for using the electrostatic spray system 10 of FIG. 1. The process 60 may advantageously gradually reduce electric charge to zero while spraying to allow electric charge to dissipate. Thus enabling fabrication of a product (e.g., medical product) with the proper finishes and tolerances using a material with a slow electrical charge decay rate. The process 60 begins by turning on the electrostatic system 10, represented by step 62. The user then selects the particular operating mode that runs process 60 and the associated operating parameters (e.g., voltage level, amount of material to be sprayed, how long will voltage be applied, etc.) using the interface 20. The controller 18 receives this information from the user interface 20 and uses the information to operate the system 10. Specifically, the controller 18 uses the processor 22 to execute instructions contained in the memory 24.

After receiving instructions from the controller 18, the electrostatic tool 12 applies electric charge to material coming from the material source 22, represented by step 64. The electric charge may be specific to the mode (i.e., positive or negative charge and approximately between 5-100 kV). The electric charge may be user adjustable, tied to the mode, and/or auto adjustable. The process 60 then begins spraying the electrically charged material using the electrostatic tool 12, represented by step 66. As explained above, some materials once electrically charged do not lose charge quickly; that is, they have a slow rate of electrical charge decay. Accordingly, the material already on the target 24 may repel freshly sprayed electrically charged material, creating poor finishes or improper tolerances.

Advantageously, the process 60 allows the excessive electrical charge to dissipate. Specifically, the electrostatic tool 12 may gradually reduce the electric charge applied to the material to zero over a period of time, represented by step 68. The rate at which the electrostatic tool 12 changes the electric charge depends on the material's ability to lose electrical charge. For example, if the material sprayed takes a long time to lose electrical charge, then the electrostatic tool may rapidly reduce the amount of electrical charge imparted to the material. For materials that may dissipate electric charge more quickly the rate may be slower (i.e., the electrostatic tool 12 may slowly reduce the amount of charge added to the material being sprayed). The process step 68, therefore, enables the material to lose electrical charge by reducing the amount of additional electrical charge over time. The decay in electrical charge may, therefore, reduce the ability of the applied material to repel, additional material thereby improving the finish and/or tolerances. As explained above, the electrical charge may decay by traveling to ground through the mandrel, dissipating into the freshly sprayed material that contains less electrical charge, and/or traveling through the air to the grounded electrostatic tool 12. The process 60 may then stop spraying material, represented by step 70. Depending on the product or coating, the process 60 may repeat after a specific time period (e.g., flash period or partial cure period). For example, the process 60 may repeat multiple times (e.g., 1, 2, 3, 4, 5, 10, 15, 20 or more times) before producing a finished product or coating.

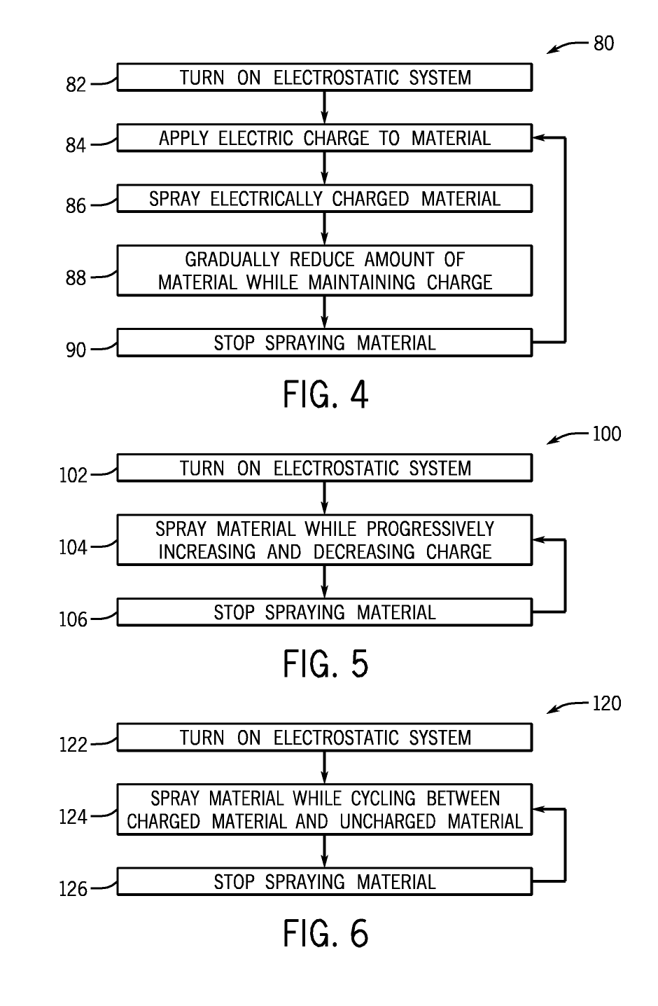

FIG. 4 is a flowchart of an exemplary method 80 for using the electrostatic spray system 10 of FIG. 1. This process 80 may advantageously gradually spray less electrically charged material to allow electric charge to dissipate. Thus enabling fabrication of a product (e.g., medical product) with the proper finishes and tolerances using a material with a slow electrical charge decay rate. The process 80 begins by turning on the electrostatic system 10, represented by step 82. The user then selects the particular operating mode that runs process 80 and the associated operating parameters (e.g., voltage level, amount of material to be sprayed, how long voltage will be applied, etc.) using the interface 20. The controller 18 receives this information from the user interface 20 and then executes instructions stored in the memory 24 to operate the system 10.

After receiving instructions from the controller 18, the electrostatic tool 12 applies electric charge to material coming from the material source 22, represented by step 84. The electric charge will be specific to the mode (i.e., positive/negative charge and approximately between 5-100 kV). The process 80 then begins spraying the electrically charged material using the electrostatic tool 12, represented by step 86. As explained above, some materials once electrically charged do not lose charge quickly and may repel freshly sprayed electrically charged material, creating poor finishes or improper tolerances. Advantageously, the process 80 allows the electrical charge to dissipate while adding limited amounts of additional electric charge. Specifically, in step 88 of the process 80, the system 10 gradually reduces the amount of material sprayed over time while maintaining the electric charge on the material being sprayed. Accordingly, by spraying less material less charge is added over time, thus enabling the charge to decay. As the charge decays, the applied material is less likely to repel additional material and, therefore, produces an improved finish and/or tolerance. The process 80 may then stop spraying material, represented by step 90. Depending on the product or coating, the process 80 may repeat after a specific time period (e.g., flash period or partial cure period). For example, the process 80 may repeat multiple times (e.g., 1, 2, 3, 4, 5, 10, 15, 20 or more times) before producing a finished product or coating.

FIG. 5 is a flowchart of an exemplary method 100 for using the electrostatic spray system 10 of FIG. 1. This process 100 may advantageously increase and decrease electric charge on the sprayed material, allowing the material to lose electric charge during periods when the sprayed material has less electrical charge. Thus enabling fabrication of a product (e.g., medical product) with the proper finishes and tolerances using a material with a slow electrical charge decay rate. The process 100 begins by turning on the electrostatic system 10, represented by step 102. The user then selects the particular operating mode that runs process 100 and the associated operating parameters (e.g., voltage level, amount of material to be sprayed, how long voltage will be applied, how quickly the voltage will increase or decrease, etc.) using the interface 20. The controller 18 receives this information from the user interface 20 and then executes instructions stored in the memory 24 to operate the system 10.

After receiving instructions from the controller 18, the electrostatic tool 12 adds an electric charge to a material as it sprays the material. The electric charge will be specific to the mode (i.e., positive/negative charge and approximately between 5-100 kV). More specifically, the electrostatic tool 12 will progressively increase and progressively decrease the charge on the sprayed material, represented by step 104. For example, the controller 18 may direct the electrostatic tool 12 to increase the voltage on the material from 5 to 100 kV over a period of time (e.g., 1, 2, 3, 4, 5, 10, 15, 20, 25, 30, or more seconds) and to then decrease the voltage from 100 to 5 kV over another time period (e.g., 1, 2, 3, 4, 5, 10, 15, 20, 25, 30 or more seconds). The time period may be user adjustable, or auto adjustable based on feedback from electrical charge flowing through the target (e.g., mandrel). Furthermore, the controller 18 may direct the electrostatic tool 12 to repeat this step 104 multiple times (e.g., 1, 2, 3, 4, 5, 10, 20, 30 or more times). As explained above, when the material retains charge, it negatively affects the finish or tolerances of the final coating or product by repelling freshly sprayed material. Advantageously, the process 100 allows the electrical charge to dissipate during periods when the electrostatic tool 112 applies less electric charge to the sprayed material. Accordingly, by alternating or periodically increasing and decreasing the charge on the sprayed material, the charge on the material is able to decay so that the applied material does not repel additional material, thereby improving the finish and/or tolerance. The process 100 may then stop spraying material, represented by step 106. Depending on the product or coating, the process 100 may repeat after a specific time period (e.g., flash period or partial cure period). For example, the process 100 may repeat itself multiple times (e.g., 1, 2, 3, 4, 5, 10, 15, 20 or more times) before producing a finished product or coating.

FIG. 6 is a flowchart of an exemplary method 120 for using the electrostatic spray system 10 of FIG. 1. This process 120 may advantageously remove all electric charge and then add electric charge during the spraying process to allow the electric charge to dissipate. Thus enabling fabrication of a product (e.g., medical product) with the proper finishes and tolerances using a material with a slow electrical charge decay rate. The process 120 begins by turning on the electrostatic system 10, represented by step 122. The user then selects the particular operating mode that runs process 120 and the associated operating parameters (e.g., voltage level, amount of material to be sprayed, how long voltage will be applied, etc.) using the interface 20. The controller 18 receives this information from the user interface 20 and then executes instructions stored in the memory 24 to operate the system 10.

After receiving instructions from the controller 18, the electrostatic tool 12 adds an electric charge to a material as it sprays the material. The electric charge will be specific to the mode (i.e., positive/negative charge and approximately between 5-100 kV). More specifically, the electrostatic tool 12 will cycle between adding charge and removing all charge from the sprayed material, represented by step 124. For example, the controller 18 may execute instructions that direct the electrostatic tool 12 to add a voltage to the sprayed material between 5-100 kV for a specific period of time (e.g., 1, 2, 3, 4, 5, 10, 15, 20, 25, 30 or more seconds) and to then remove all charged on the sprayed material for another time period (e.g., 1, 2, 3, 4, 5, 10, 15, 20, 25, 30 or more seconds). The time period may be user adjustable, or auto adjustable based on feedback from electrical charge flowing through the target (e.g., mandrel). Depending on the embodiment, the time period of spraying charged material may shorter or longer than the time period for spraying uncharged material. As explained above, if the material does not lose the added charge quickly the remaining charge may negatively affect the finish or tolerances of the final coating or product by repelling freshly sprayed material. Advantageously, the process 120 allows the electrical charge to dissipate by cycling between spraying electrically charged material followed by uncharged material in order to produce a coating or product with the proper finish and/or tolerances. The process 120 may then stop spraying material, represented by step 126. Depending on the product or coating the process 120 may repeat itself after a specific time period (e.g., flash period or partial cure period). For example, the process 120 may repeat multiple times (e.g., 1, 2, 3, 4, 5, 10, 15, 20 or more times) before producing a finished product or coating.

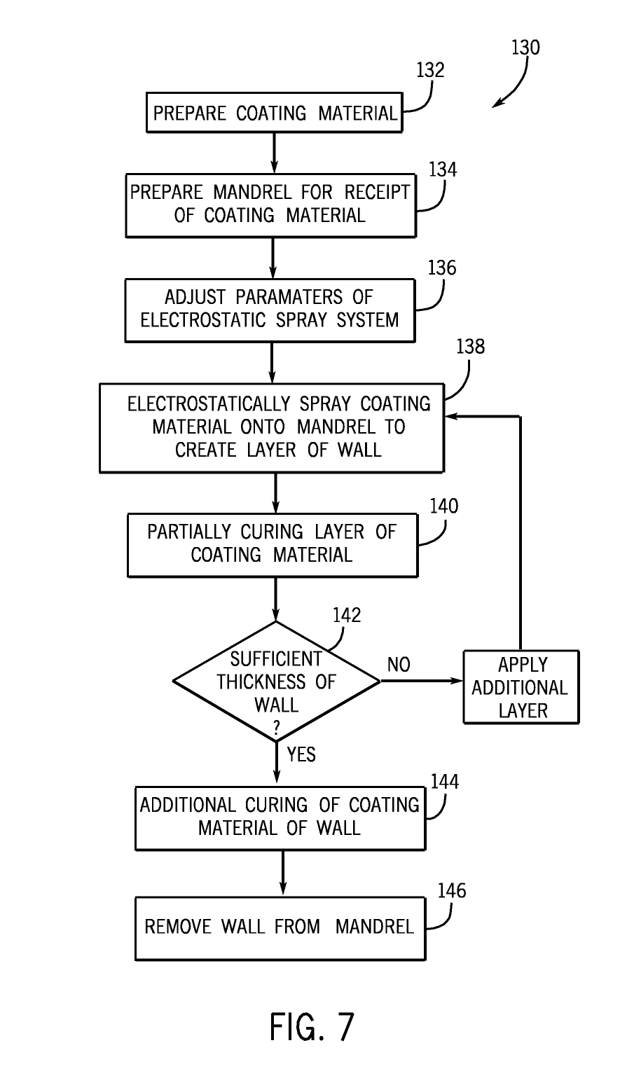

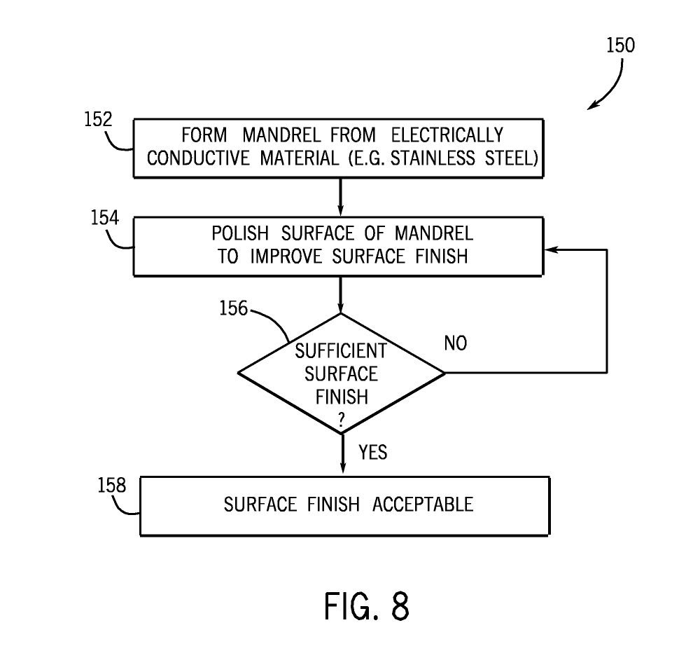

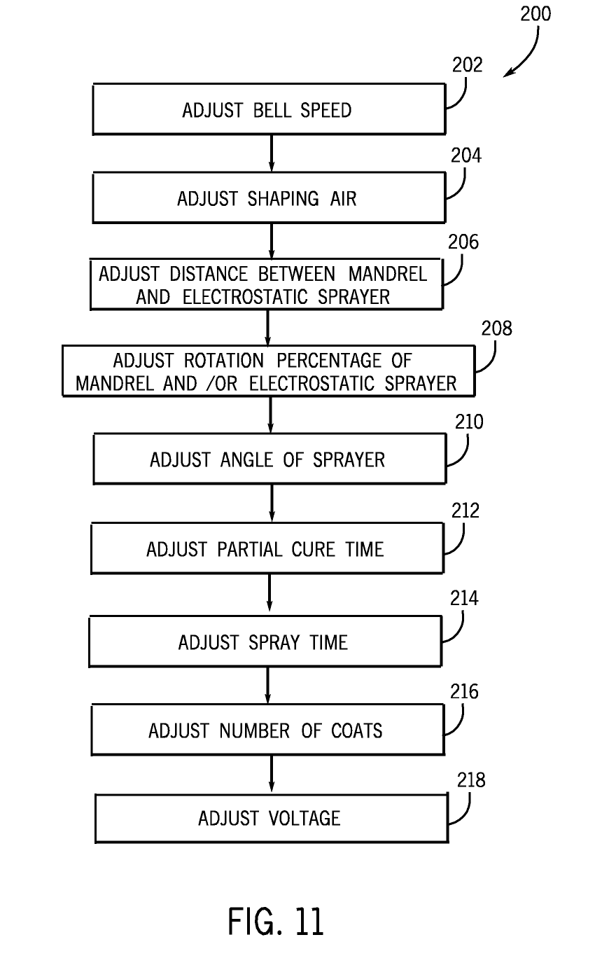

FIG. 7 is a flowchart of an exemplary method 130 for electrostatically producing a part. For example, the part may be a resilient shell, casing, or enclosure, such as a resilient bag, pouch, or container. In certain embodiments, the part may include a resilient wall disposed about an interior cavity, which may be used to store or contain a substance. Examples include a medical bag or surgical implant. The method 130 enables fabrication of a part (e.g., medical product or part) with the proper finishes and tolerances. The method 130 begins by preparing a coating material (block 132). As discussed above, the coating material may be a polymer material with a slow rate of charge decay (silicon, polyethylene terephtalate (PET), low density polyethylene (LDPE), polyethylene films, etc.). Preparation of the coating material may involve adding a solvent such as xylene, heptane, hexane or isopropyl alcohol solution to the polymer to achieve the proper viscosity. More specifically, preparing of the coating material may involve adjusting the viscosity of the material to achieve a viscosity between 20-400 centipoise, thus enabling the coating material to flow properly after contacting the mandrel 24. In order to produce the part with the proper clarity/transparency, the mandrel is prepared for receipt of the coating material (block 134). As will be discussed in additional detail in FIGS. 8-10, the mandrel 24 may be prepared in various ways that enable the part to achieve the proper clarity/transparency. For example, the mandrel 24 and/or a low friction coating may be polished to provide a smooth surface finish. Specifically, a smooth surface finish of the mandrel 24 reduces imperfections in the surface of the part, which improves clarity/transparency (i.e., reduces light refraction). The next step in method 130 involves adjusting parameters of the electrostatic spray system (block 136). The electrostatic spray system 10 may be adjusted in various ways in order to produce the part with the proper tolerances. As will be discussed in additional detail in FIG. 11, the adjustable parameters include bell speed, shaping air, distance between sprayer and mandrel 24 (i.e., target), rotation percentage or degrees of rotation of the mandrel or electrostatic sprayer, angle of the electrostatic sprayer relative to the mandrel 24, partial cure time of the coating material (i.e., flash time) between coatings, the amount of time the coating material is sprayed, the number of coatings, and the voltage applied to the material. After adjusting the parameters of the electrostatic spray system 10, a user may select one of the processes described above in FIGS. 2-6 for electrostatically spraying the coating material onto the mandrel 24 to create a layer of wall (i.e., coating) (block 138). The method 130 then enables the sprayed material (i.e., a layer of material) to partially cure for a period of time (i.e., flash) (block 140). As explained above, the cure time is one of the parameters adjusted by the method 130 in the step adjusting the parameters of the electrostatic spray system (block 136). After partially curing, the method 130 determines whether the wall/coating is sufficiently thick (block 142). If the coating is insufficiently thick, the process 130 returns to block 138 and electrostatically sprays another coating material onto the mandrel to create another layer of wall. The method 130 repeats this portion of the method until the coating/layer of wall meets the requisite thickness (i.e., tolerances). The thickness of the wall may be measured at the decision point or may be predetermined based on previous calculations (i.e., if the number of wall layers or coatings needed to achieve the proper thickness is known). If the wall is sufficiently thick (i.e., meets tolerances), the method 130 enables additional curing of the coating material of wall (block 144). Once the wall (i.e., part) is cured, the wall is removed from the mandrel (block 146).

FIG. 8 is a flowchart of an exemplary method 150 for preparing a mandrel (i.e., target) as indicated by block 134 of FIG. 7. As explained above, a smooth surface finish of the mandrel reduces imperfections in the surface of the part that can affect clarity/transparency. In particular, a reduction in surface imperfections of the part improves clarity/transparency (i.e., reduces light refraction). Accordingly, the method 150 produces a mandrel that enables production of parts with the proper clarity/transparency. The method 150 begins by forming a mandrel from an electrically conductive material (e.g., stainless steel, P20 steel, aluminum, titanium, etc.) (block 152). The mandrel surface is then polished to improve the surface finish to between a number four and a number eight minor finish (e.g., a number four, five, six, seven, or eight minor finish). The mandrel surface may be polished using a variety of methods, such as a belt grinder, polishing wheel, grit specific greaseless compound, non woven abrasive belt/pad, microfiber polishing fabric, etc. After polishing the mandrel, the method 150 determines whether the surface finish is sufficient (block 156). If the surface finish is insufficient the method 150 repeats the step of polishing the surface of the mandrel to improve the surface finish (block 154). If the surface finish is acceptable, the method 150 stops (block 158). At this stage, the prepared mandrel (block 134) may be used to produce the part (e.g., wall) as set forth by steps 136 through 146 of FIG. 7.

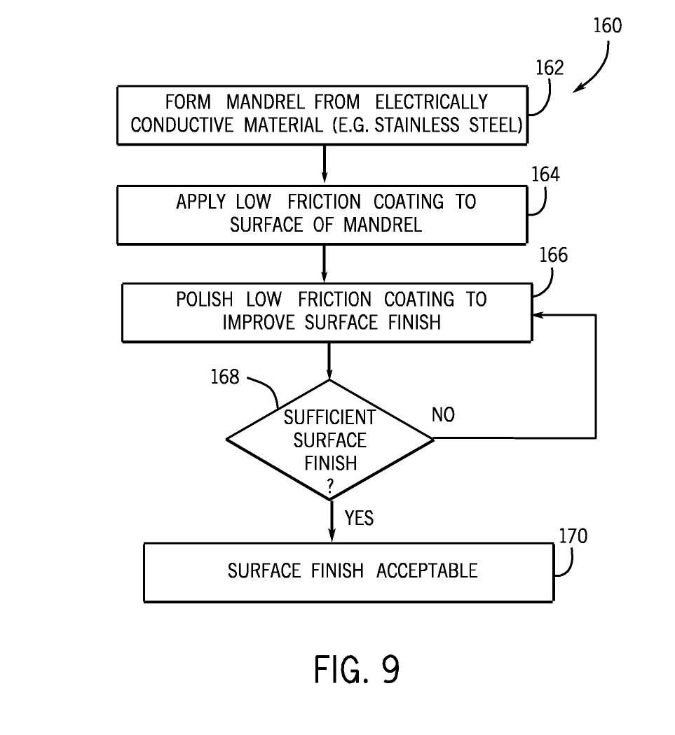

FIG. 9 is a flowchart of an exemplary method 160 for preparing a mandrel with a coating as indicated by block 134 of FIG. 7. As explained above, a smooth surface finish of the mandrel reduces imperfections in the part that can affect clarity/transparency. Accordingly, the method 160 produces a mandrel with a coating that enables production of parts with the proper clarity/transparency, while also easing removal of the part from the mandrel. The method 160 begins by forming a mandrel from an electrically conductive material (e.g., stainless steel, P20 steel, aluminum, titanium, etc.) (block 162). A low friction coating is then applied to a surface of the mandrel (block 164). The low friction coating may be a polytetrafluoroethylene (PTFE), a fluorinated ethylene propylene (tetrafluoroethylene), hexafluoropropylene (FEP), perfluoroalkoxy (PFA), etc. The low friction of the coating may simplify or ease removal of the part from the mandrel after completion of all layers of the wall. Furthermore, the low friction of the coating may reduce creation of imperfections during the removal of the part from the mandrel, e.g., due to the layers sticking to the mandrel and tearing. Again, the reduction in surface imperfections increases the clarity/transparency of the part. The coating is then polished to improve the surface finish to between a number four and a number eight minor finish (e.g., a number four, five, six, seven, or eight minor finish) (block 166). The coating may be polished using a variety of methods such as a belt grinder, polishing wheel, grit specific greaseless compound, non woven abrasive belt/pad, microfiber polishing fabric, etc. After polishing the low friction coating, the method 160 determines whether the surface finish is sufficient (block 168). If the surface finish is insufficient, the method 160 repeats the step of polishing the surface of the low friction coating to improve the surface finish (block 166). If the surface finish is acceptable the method 150 stops (block 170). At this stage, the prepared mandrel (block 134) may be used to produce the part (e.g., wall) as set forth by steps 136 through 146 of FIG. 7.

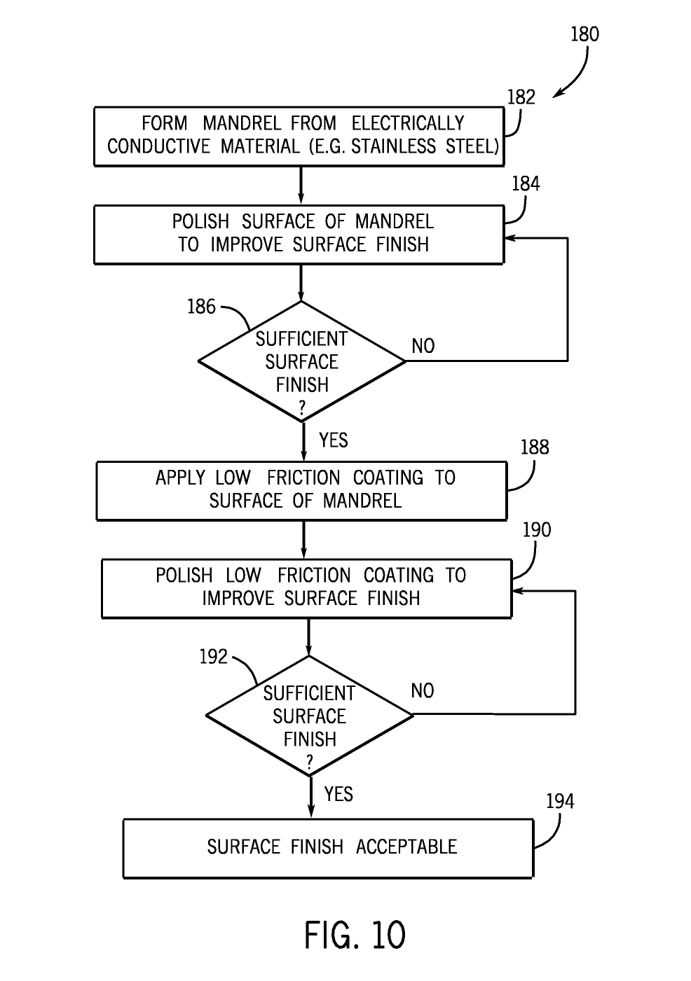

FIG. 10 is a flowchart of an exemplary method 180 for preparing a mandrel with a low friction coating as indicated by block 134 of FIG. 7. As explained above, a smooth surface finish of the mandrel reduces imperfections in the surface of the part that affect clarity/transparency. In particular, a reduction in surface imperfections of the part improves clarity/transparency (i.e., reduces light refraction). The method 180 begins by forming a mandrel from an electrically conductive material (e.g., stainless steel, P20 steel, aluminum, titanium, etc.) (block 182). The mandrel is then polished to improve the surface finish (block 184). The mandrel may be polished using a variety of methods such as a belt grinder, polishing wheel, grit specific greaseless compound, non woven abrasive belt/pad, microfiber polishing fabric, etc. After polishing the mandrel, the method determines whether the surface finish is satisfactory for applying the low friction coating (block 186). If the surface finish is inadequate, the method 180 repeats the step of polishing the surface of the mandrel to improve the surface finish (block 184). If the surface finish is acceptable, the next step is to apply a low friction coating to the mandrel surface (block 188). The low friction coating may be a polytetrafluoroethylene (PTFE), a fluorinated ethylene propylene (tetrafluoroethylene), hexafluoropropylene (FEP), perfluoroalkoxy (PFA), etc. The low friction of the coating may simplify or ease removal of the part from the mandrel after completion of all layers of the wall. Furthermore, the low friction of the coating may reduce creation of imperfections during the removal of the part from the mandrel, e.g., due to the layers sticking to the mandrel and tearing. Again, the reduction in surface imperfections increases the clarity/transparency of the part. The coating is then polished to improve the surface finish to between a number four and a number eight mirror finish (e.g., a number four, five, six, seven, or eight minor finish) (block 190). The coating may be polished using a variety of methods such as a belt grinder, polishing wheel, grit specific greaseless compound, non woven abrasive belt/pad, microfiber polishing fabric, etc. After polishing the coating, the method 180 determines whether the surface finish is sufficient (block 192). If the surface finish is insufficient, the method 180 repeats the step of polishing the coating surface to improve the surface finish (block 190). If the surface finish is acceptable, the method 180 stops (block 194). At this stage, the prepared mandrel (block 134) may be used to produce the part (e.g., wall) as set forth by steps 136 through 146 of FIG. 7.

FIG. 11 is a flowchart of an exemplary method 200 for adjusting the parameters (block 136) in the method 130 for electrostatically producing a part as illustrated in FIG. 7. As explained above, the electrostatic system 10 includes a user interface 20. The user interface 20 enables a user to adjust operating parameters in order to produce the part within the proper specifications. Specifically, the user may adjust parameters based on the type of mandrel (including mandrel coatings), coating material, or changes in tolerances. For example, a mandrel with a friction reducing coating may increase the flow of a coating material, while a mandrel without a friction reducing coating (i.e., low friction coating) may reduce coating material flow. Accordingly, a user may adjust parameters of the electrostatic spray system to adjust for changes in part tolerances, types of mandrels, mandrel coatings, etc.

The method 200 begins with step 202 adjusting the bell speed of the rotary atomizer. The bell speed directly controls particle size (i.e., by shearing fluid at an edge of a bell). As the bell speed increases, it creates finer particles by breaking up the coating material. The finer particles are more easily charged and therefore improve uniform coating of the mandrel. The bell speed may be adjusted between 15-60 kRPM, 25-55 kRPM, 35-55 kRPM, or 45-55 kRPM. In step 204, the method 200 adjusts the speed, flow rate, pressure, or any combination thereof, of the shaping air. The shaping air transports the coating material from the sprayer to the mandrel and affects the pattern size of the coating material. More specifically, increasing the speed of the shaping air reduces the ability of the material to spread, while decreasing the speed facilitates scatter of the coating material. In the method 200, the shaping air may adjust between 1-20 PSI, 2-10 PSI, or 2-5 PSI to adjust the speed of the shaping air. In step 206, the method 200 adjusts the distance between the mandrel and the electrostatic sprayer. The distance between the sprayer and the mandrel affects pattern size, loss of electric charge, and drying of the coating material. More specifically, a greater distance between the mandrel and the sprayer increases the scatter of the material, causes greater loss of electric charge to the environment, and can cause the material to partially cure before contacting the mandrel. Moreover, a lesser distance reduces scatter, increases charge retention, and prevents the coating material from partially curing. The method may adjust the distance between 3-12 inches, 5-10 inches, or 6-9 inches. In step 208, the method 200 adjusts the rotation percentage/degree of rotation of the mandrel and/or the electrostatic sprayer, in order to enable adequate coating of the mandrel (i.e., around a circumference of the mandrel). For example, in some embodiments, the mandrel may rotate about its axis while the electrostatic sprayer sprays material from a fixed position. In other embodiments, the electrostatic sprayer may rotate around the mandrel while the mandrel remains fixed. The rotation of the electrostatic sprayer or the mandrel may be adjusted between 5-100 degrees, 50-90 degrees, or 65-85 degrees about their respective axis. In step 210 the angle of the sprayer may be adjusted with respect to the mandrel. Specifically, the angle of the sprayer may be between 20-70 degrees, 30-60 degrees, 40-50 degrees below the horizontal position of the mandrel. In step 212, the method 200 adjusts the partial cure time of the coating material. In some embodiments, the coating material may be applied in a series of coats with partial cures between coats. The partial cures block excess flow of the coating material as multiple coats are added. The partial cure time may be adjusted between 0-180 seconds, 5-100 seconds, 10-60 seconds, or 20-40 seconds. The method 200 may then adjust the spray time in step 214, depending on the thickness or number of coats. The spray time may be adjusted between 1-90 seconds, 2-15 seconds, or 3-8 seconds. In step 216, the method 200 enables adjustment of the number of material coatings. As explained above, the material may be sprayed in a series of coats to block excess material flow by partially curing each coat. Accordingly, step 216 enables a user to adjust the number of coats to reach the proper tolerances (i.e., thicknesses). For example, the product may be coated with 1, 2, 3, 4, 5, 6, 7, 8, 9, 10 or more coats. Finally, in step 218, the method 200 enables adjustment of the applied voltage. As explained above in FIGS. 2-6, the voltage may vary between approximately 5 kV and 100 kV, in order to improve proper product finishes and tolerances, as slow electrical charge decay may interfere as the material starts to repel itself.

For example in one embodiment the method 200 may produce a part using the following parameters: bell speed 35-55 kRPM, shaping air 2-10 PSI, distance between sprayer and mandrel 24 5-10 inches, rotation percentage or degrees of rotation of the mandrel or electrostatic sprayer 50-90 degrees, angle of the electrostatic sprayer relative to the mandrel 24 30-60 degrees, partial cure time of the coating material between coatings 10-60 degrees, the amount of time the coating material is sprayed 2-15 seconds, the number of coatings 5, and the voltage applied to the material 50 kV. In another embodiment, the method 200 may produce a part with the following parameters: bell speed 45-55 kRPM, shaping air 2-5 PSI, distance between sprayer and mandrel 24 6-9 inches, rotation percentage or degrees of rotation of the mandrel or electrostatic sprayer 65-85 degrees, angle of the electrostatic sprayer relative to the mandrel 24 40-50 degrees, partial cure time of the coating material between coatings 20-40 degrees, the amount of time the coating material is sprayed 3-8 seconds, the number of coatings 3, and the voltage applied to the material 75 kV.

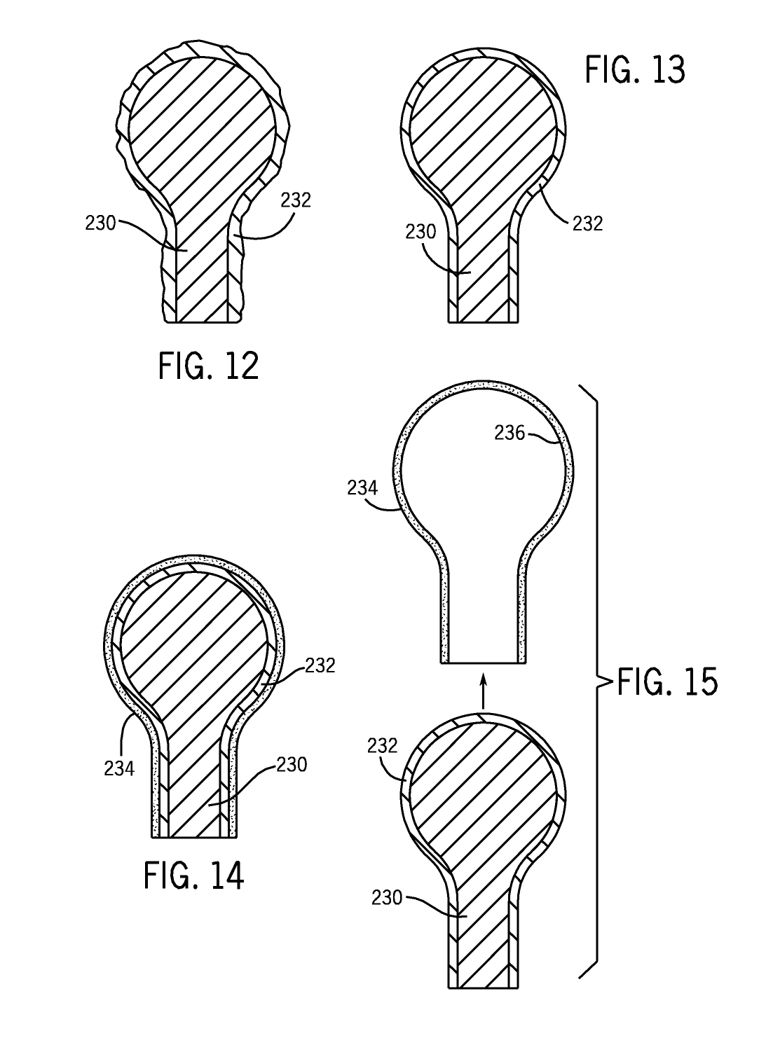

FIG. 12 is a cross-sectional view of a mandrel 230 with an unpolished coating 232. As explained above, the mandrel 230 may include a low friction coating 232 (e.g., polytetrafluoroethylene (PTFE), a fluorinated ethylene propylene (tetrafluoroethylene), hexafluoropropylene (FEP), perfluoroalkoxy (PFA), etc.). The low friction coating facilitates removal of the part after spraying. Moreover, the low friction coating also reduces formation of additional defects, tears, or the like, which in turn helps to improve clarity. However, the coating 232 is an unpolished rough surface that may increase imperfections of the coating material. As explained above, the imperfections increase light refraction and therefore reduce clarity/transparency in the part.

FIG. 13 illustrates a cross-sectional view of the mandrel 230 with a polished coating 232. The coating 232 may be polished to create a surface finish between a number four and a number eight minor finish (e.g., a number four, five, six, seven, or eight minor finish) using the method 160 or 180. As explained above, an improved surface finish of the mandrel coating 232 enables the coating material to smoothly coat on top of the mandrel coating 232, reducing imperfections, and thus improving clarity/transparency of the coating material.

FIG. 14 is a cross-sectional view of the mandrel 230 with the polished coating 232 and an electrostatically sprayed part 234. As explained above, the part 234 is electrostatically sprayed with process 130. The process 130 in combination with the sub-processes discussed in FIGS. 2-6 and 8-11 facilitate production of the part 134 with the proper tolerances and qualities (e.g., clarity/transparency, material type, etc.). More specifically, the process 130 enables production of the part 134 with the proper tolerances and qualities by adjusting the parameters including bell speed, shaping air, distance between sprayer and mandrel (i.e., target), rotation percentage of mandrel or electrostatic sprayer, angle of the electrostatic sprayer, partial cure time of the coating material (i.e., flash time), the amount of time the coating material is sprayed, the number of coatings, and the voltage applied to the material.

FIG. 15 is a cross-sectional view of the mandrel 230 with a polished coating 232 separated from an electrostatically sprayed part 234. As explained above, the polished low friction coating may facilitate removal of the part after spraying, as well as improve the clarity/transparency of the part 234. More specifically, the polished coating 232 reduces imperfections on the interior surface 236 of the part 234, thus reducing light refraction and increasing the clarity/transparency of the part 234.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A system, comprising:
an electrostatic spray system, comprising:
an electrostatic tool configured to spray a material with an electrostatic charge; and
a target with a surface finish greater than or equal to a number 4 mirror finish configured to receive a material sprayed by the electrostatic tool.

2. The system of claim 1, wherein the target includes a friction reducing coating.

3. The system of claim 2, wherein the friction reducing coating has a surface finish between a number four and a number eight minor finish.

4. The system of claim 3, wherein the friction reducing coating comprises polytetrafluoroethylene (PTFE), fluorinated ethylene propylene (tetrafluoroethylene), hexafluoropropylene (FEP), or perfluoroalkoxy (PFA).

5. The system of claim 1, wherein the target is a mandrel.

6. The system of claim 5, wherein the mandrel is made of an electrically conductive material.

7. The system of claim 6, wherein the electrically conductive material comprises stainless steel.

8. The system of claim 1, wherein the electrostatic tool comprises a rotary atomizer.

9. A system comprising:
an electrostatic spray system controller configured to change operating parameters of a electrostatic spray system that discharges electrically charged material with slow rates of electrical charge decay.

10. The system of claim 9, wherein the electrostatic sprayer system includes an electrostatic tool configured to spray the electrically charged material at a target.

11. The system of claim 10, wherein the controller includes a processor.

12. The system of claim 11, wherein the controller includes a memory with instructions for the processor, and wherein the instructions change parameters of the electrostatic sprayer system.

13. The system of claim 12, wherein the parameters include a bell speed of the electrostatic tool, a speed of shaping air, a distance between the electrostic tool and the target, a rotation percentage of the target or the electrostatic tool, an angle of the electrostatic tool, a partial cure time of the electrically charged material, a spraying duration of the electrically charged material, a number of coatings, and a voltage applied to the electrically charged material.

14. The system of claim 9, wherein the controller is configured to remove an electric charge from the material while the electrostatic tool is spraying the material.

15. A method for producing a target for an electrostatic spray system, comprising:
forming a target with electrically conductive material; and
polishing a target surface of the target.

16. The method of claim 15, wherein polishing the target surface comprises polishing to at least a number four minor finish.

17. The method of claim 15, comprising applying a low friction coating to the target surface.

18. The method of claim 17, comprising polishing the low friction coating to at least a number four mirror finish.

19. A method for producing a target for an electrostatic spray system comprising:
forming a target with an electrically conductive material;
applying a low friction coating to a surface of the target;
polishing the low friction coating to at least a number four minor finish.

20. A method for producing a part with an electrostatic spray system, comprising:
preparing a coating material;
preparing a target for receipt of the coating material;
adjust parameters of the electrostatic spray system;
electrostatically spraying a coating material onto the target to create a layer of a wall;
partially curing the layer of coating material;
determining if a thickness of the wall is equal to or greater than a threshold;
applying another layer of the coating material if the thickness is less than the threshold;
curing the coating material; and
removing the wall from the target.
